(19) United States
(12) Patent Application Publication
(10) Pub. No.: US 2004/0202768 A1
(43) Pub. Date: Oct. 14, 2004

(54) Juices incorporating early season orange cultivars

(76) Inventors: James H. Keithly, Bradenton, FL (US); Harold Pollack, St. Petersburg, FL (US); Thomas Taggart, Bradenton, FL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/833,861

(22) Filed: Apr. 28, 2004

Related U.S. Application Data
(63) Continuation of application No. 10/456,859, filed on Jun. 6, 2003.
Application No. 10/456,859 is a continuation of application No. 09/545,397, filed on Apr. 7, 2000, now abandoned.
Application No. 09/545,397 is a continuation-in-part of application No. 09/311,956, filed on May 14, 1999, now Pat. No. 6,143,347.

(51) Int. Cl. A23L 2/00

(52) U.S. Cl. 426/599

(57) ABSTRACT

Orange juice is provided which includes as a component juice extracted from a very early season round orange cultivar which is not a Hamlin cultivar. The juice extracted from such very early season cultivar has sensory attributes which are superior to those of Hamlin fresh juice. The very early season juice has a Brix-to-acid ratio and a color intensity in excess of those provided by Hamlin cultivars which are harvested at the same time as the very early season cultivar. Preferred very early season cultivars are within the Seleta family or are Westin cultivars or are Ruby Nucellar cultivars.

### CROSS REFERENCE TO RELATED APPLICATION

This is a continuation-in-part of application Ser. No. 09/311,956, dated May 14, 1999.

### BACKGROUND OF THE INVENTION

This invention generally relates to juices which are prepared from orange juice sources which incorporate juices from early season orange tree cultivars which have be discovered to exhibit improvements over traditional early season round oranges, especially Hamlin round oranges. Included are juices which have not been subjected to procedures which concentrate the juice. In the citrus industry, these types of juice products are known as being “not from concentrate” juices. So called “from concentrate” juices are included for some of these early season cultivars. More particularly, the invention relates to an improved early season juices which consistently exhibit important sensory improvements and unusually high Color Number values. These enhancements are particularly valuable due to their being provided by fresh juice sources according to the invention during the time period which is early in the orange fruit bearing or harvest season.

When considering the not from concentrate orange juice industry, a persistent problem is the maintenance of superior sensory attributes and a consistent, deep rich orange color throughout the year. This problem is especially difficult during the early fruit-harvesting season of orange trees. It will be appreciated that different varieties or cultivars of orange trees bear harvest-ready fruit at somewhat different times within the overall citrus growing season. In the Northern Hemisphere, traditionally the overall citrus growing season extends between approximately October and June. Generally speaking, Valencia round oranges can be considered to provide a bench mark for orange juice quality, both with respect to analytical properties and sensory properties. Many not from concentrate juices are a blend of freshly squeezed juice with stored juice, which can be stored Valencia juice, for example. Valencia cultivars tend to have a growing season which is in a later portion of the overall round orange harvest season. A typical Valencia season runs between about late February and early June. Other round oranges such as Hamlin oranges are early season harvested for freshly squeezed orange juice, such as during approximately the months of October, November and December. Certain orange cultivars such as Pineapple oranges have a mid-season harvest characteristic, running between about January and early March.

In the not from concentrate juice industry, particularly when Valencia oranges are not yet in season, the freshly squeezed juice component can be one of these earlier maturing varieties. At present, the principal early season variety for providing the freshly squeezed orange juice component is the Hamlin variety. One of the drawbacks of Hamlin round oranges is that a Hamlin round orange crop does not, in general, meet all of the quality standards of Valencia round oranges. Some of these relate to sensory attributes; others relate to chemical analyses and to color.

Sensory attributes include data which can relate to sweetness/tartness balance, strength of orange flavor, and the like, as well as other sensory detectible components. Sensory attributes can be gauged by recognized testing procedures, typically of a type which rely upon the detection of specific sensory components by trained panels. Tabulations of the responses of the panelists provide flavor and sensory profile results which quantify the sensory characteristics of the juices. These results allow a generally objective evaluation of important sensory components such as green character, bitterness, chemical notes, raw flavors, total orange flavors, and the like.

Important chemical analysis standards include total minimum solids percentage (or Brix), citric acid content, and Brix to acid ratio (or BAR). Other analysis parameters include percentage of oil and percentage of vitamin C. Chemical analyses have long been used in the citrus industry to gauge characteristics of the chemical make-up of a fruit or juice. It will be appreciated that each of these characteristics is well understood in the fruit and produce industries, and especially within the citrus fruit and commercial juice industry. They long have been important in judging the quality of fruit. For example, a Brix difference of 0.8° is detectible, from a sensory point of view, when comparing different orange juice products.

Color is a property of juices which can be measured in an objective manner for purposes of evaluating the color acceptability of a particular type of juice. In the case of citrus juices, the industry generally recognizes a parameter referred to as Color Number. Details of color determination, including procedures, equipment and standards, are found in Redd, Hendrix and Hendrix, Quality Control Manual for Citrus Processing Plants, Volume 1: Regulation, Citrus Methodology, Microbiology, Conversion Charts, Tables, Other; 1986; Intercit., Inc., Safety Harbor, Fla. A calorimeter is a primary component of the Color Number determination procedure. Redd et al provides specific calibration information for a variety of such instruments, including HunterLab Model D45, HunterLab Model D45D2, HunterLab LabScan Colorimeter Model LS-5100, MacBeth Color-Eye Colorimeter Model 1500 and Minolta Portable Colorimeter Model Chroma Meter II Reflectants/CR 100.

These objective Color Number data are important components of categorizing single strength orange juice as, for example, Grade A or Grade B juice. A Grade B orange juice has a Color Number of between 32 and 35 CN units. A Grade A orange juice has a Color Number of between 36 and 40 CN units. A high quality not from concentrate orange juice seeks to meet the Grade A standard, although this is not always possible, particularly for the earlier season juices.

In addition, it has come to be appreciated through objective testing that juice color has an important impact on consumer liking of orange juice. Sensory tests which evaluated juice properties concluded that orange juice color intensity is important to consumer acceptance and preference. Generally speaking, consumer liking for orange juice increases as the color becomes darker and more orange. It has been determined that consumers can clearly detect an increase in color of as low as 1 Color Number or Color value unit. The testing included juices having various Color Numbers, ranging between about 34 CN to about 42 CN. Juices having a higher Color Number in a comparison set were chosen as more desirable. Accordingly, it now has come to be appreciated that color intensity is a very important characteristic of orange juice products in general and of not from concentrate orange juice in particular.

These various characteristics are very important in maintaining or enhancing consumer acceptance of orange juice. These characteristics of sensory profile, chemical analysis standards, and color intensity each are important to evaluating juice quality, Even though color has been found to be very important in consumer acceptance, superior color intensity should not be achieved at the expense of these other characteristics which relate to sensory qualities and chemical analysis standards.

When these factors are considered in connection with early season extracted orange juice, it would be extremely valuable to be able to maintain, and better still to improve upon, sensory, chemical and color parameters and characteristics for a freshly squeezed juice blend component, when gauged against the current industry standard early season orange source. For example, color scores are traditionally low for early season round oranges, particularly Hamlin round oranges. While color has been determined to be an important component of consumer acceptance of orange juice, color enhancement cannot be achieved at the expense of maintaining the other characteristics of a first-class not from concentrate orange juice. It is also important that the color enhancement be achieved without the use of artificial colorants or coloring components which disqualify the orange juice product from falling within the standard of identity of not from concentrate orange juice. Otherwise, color enhancement would seriously negatively impact on the orange juice.

Accordingly, an important need exists for an approach to enhance early season juice collections in their sensory attributes and in their color, especially in not from concentrate orange juice products. These enhancements provide such products with important, tangible and economically valuable benefits when compared with previously available not from concentrate juice products, as well as “from concentrate” orange juice products and the like. It is also important that these improvements, including color enhancement, be achieved in a fully natural manner and in a way which is fully consistent with the standard of identity of not from concentrate orange juice, particularly when dealing with early season round orange harvests.

Additionally, important advantages would be realized by being able to meet the standards for freshly squeezed orange juice for not from concentrate orange juice during a time period which is earlier than that of the long-accepted early season cultivar, Hamlin round oranges. This would allow an advancement of the date by which freshly squeezed juice can be incorporated into not from concentrate orange juice, which would benefit the not from concentrate orange juice category. To do so requires that such a freshly squeezed juice source would also be able to maintain or exceed sensory and chemical characteristics of at least so-called early season juices, even during such a very early harvest time period which is earlier than that of the current so-called early-season juices. Accordingly, there is a need for an exceptionally early season source for orange juice.

### SUMMARY OF THE INVENTION

In accordance with the present invention, very early season not from concentrate orange juice is provided which has exceptional sensory characteristics and early season color. These very early season attributes are superior to those of Hamlin round oranges. This includes extracting the juice from round orange cultivar fruit that has been discovered to possess very early season sensory attributes and color intensity which are superior to those of round orange cultivars which have been in use heretofore. These cultivars possessing superior very early season color have been found to include cultivars within the Seleta family of cultivars. Non-Seleta cultivars which have been found to be useful along these lines are Westin round oranges and Ruby Nucellar round oranges. The extracted orange juice from these very early season superior sensory and color cultivars have a Color Number of at least 33 CN units. This very early season juice can be blended with other juice sources. The juices are of the not from concentrate type and have exceptional sensory characteristics and a color value above, or just below the color standards for Grade A orange juice.

Also included is a method of preparing an orange juice product incorporating an early season orange cultivar which can be of the from concentrate type. This includes harvesting a very early season orange cultivar having juice with early season color of greater intensity than Hamlin orange juice while also exhibiting sensory qualities superior to the sensory qualities of Hamlin orange juice, which cultivar is within the Seleta family of cultivars, or a combination of these very early season cultivars. Juice is extracted and collected from a volume of these very early season oranges.

When desired, at least about 5 volume percent, based on the total volume of the orange juice product, of said extracted early season orange juice is blended with another orange juice source in order to provide a blended orange juice product. Preferably, this blended juice product exhibits an enhanced sensory profile and/or a Color Number in excess of 33 CN units.

It is a general object of the present invention to provide improved early season not from concentrate orange juice.

Another object of this invention is to provide an improved method by which very early season not from concentrate orange juice sensory attributes are improved over those provided by using Hamlin round orange juice as a freshly squeezed early season cultivar of the orange juice.

Another object of this invention is to provide an improved method by which very early season not from concentrate orange juice color is improved over-that available from using Hamlin round orange juice as a freshly squeezed early season cultivar of the orange juice.

Another object of the present invention is to provide an improved not from concentrate orange juice which has enhanced early season sensory characteristics and/or chemical attributes and thus enhanced value.

Another object of the present invention is to provide an improved not from concentrate orange juice which has enhanced early season color and thus enhanced value.

Another object of the present invention is to provide an improved very early season not from concentrate orange juice which meets governmental crop maturity criteria, such as Brix-to-acid ratio and citric acid percentage, earlier in the season than do currently used early season round orange cultivars.

Another object of the invention is to provide very early season freshly squeezed orange juice products which maintain and usually exceed sensory characteristics of traditional early season freshly squeezed orange juice such as Hamlin juice.

Another object of the present invention is to provide an improved orange juice product which has enhanced sensory characteristics and/or chemical attributes and/or enhanced color, and thus enhanced value.

These and other objects, features and advantages of the present invention will be apparent from and clearly understood through a consideration of the following detailed description.

### BRIEF DESCRIPTION OF THE DRAWINGS

In the course of this description, reference will be made to the attached drawings, wherein:

FIG. 1 is a plot of Brix values for five different cultivars, showing the progression of Brix development during a portion of a Crop A growing season;

FIG. 2 is a plot of the ratio of Brix to citric acid content for Crop A;

FIG. 3 is a plot of juice Color Number for the Crop A cultivars showing color development during the indicated time period;

FIG. 4 is a plot of Brix values for five different cultivars, showing the progression of Brix development during a portion of a Crop B growing season;

FIG. 5 is a plot of citric acid values showing acid progression for the cultivars of Crop B during the indicated growing season;

FIG. 6 is a plot of the ratio of Brix to citric acid content for Crop B;

FIG. 7 is a plot of juice Color Number for the Crop B cultivars showing color development during the indicated time period;

FIG. 8 is a plot of Brix values for five different cultivars, showing the progression of Brix development during a portion of a Crop C growing season;

FIG. 9 is a plot of the ratio of Brix to citric acid content for Crop C;

FIG. 10 is a plot of juice Color Number for the Crop C cultivars showing color development during the indicated time period;

FIG. 11 is a further plot of the data in FIG. 6 and also illustrating when each Crop B cultivar met governmental BAR standards;

FIG. 12 is a further plot of BAR data for Crop C, also showing governmental BAR standards;

FIG. 13A is a regression analysis plot of feeling factors sensory data for blends including varying levels of Ruby Nucellar juice;

FIG. 13B is a regression analysis plot of sour notes sensory data for blends including varying levels of Ruby Nucellar juice;

FIG. 13C is a regression analysis plot of chemical notes sensory data for blends including varying levels of Ruby Nucellar juice;

FIG. 13D is a regression analysis plot of microbiological notes sensory data for blends including varying levels of Ruby Nucellar juice;

FIG. 13E is a regression analysis plot of cooked orange notes sensory data for blends including varying levels of Ruby Nucellar juice;

FIG. 14A is a regression analysis plot of raw orange notes sensory data for blends including varying levels of Earlygold juice; and

FIG. 14B is a regression analysis plot of bitter notes sensory data for blends including varying levels of Earlygold juice.

### DESCRIPTION OF THE PREFERRED EMBODIMENTS

orange juice in accordance with the present invention incorporates juice from round orange cultivars which are very early season varieties that can be harvested during a season approximately that of Hamlin round orange cultivars, or earlier. Unlike Hamlin round orange cultivars, however, the cultivars concerning the present invention are far superior in very early season properties than are Hamlin round oranges. These are advantageous properties which are instrumental in providing orange juice, especially advantageously including not from concentrate orange juice, which is of enhanced value for very early season use. Also advantageous is the fact that juices according to the invention exhibit flavor, color and chemical properties which are improved when compared with those provided when only Hamlin round oranges are incorporated. Accordingly, enhanced properties are imparted to the not from concentrate orange juice in accordance with the present invention without detracting from the other positive properties and characteristics of orange juice in general. When the juice is of the not from concentrate type, the result is an early season not from concentrate orange juice which is improved over that currently available, which includes incorporating freshly squeezed Hamlin orange juice.

Very early season round orange cultivars which are used in the process and included in the juice according to the present invention provide juice having improved sensory attributes, enhanced chemical properties, and Color-Number values which are consistently superior to these properties of Hamlin juice substantially throughout the harvest season for these very early round oranges. Cultivars of the invention have been found to possess each of superior sensory qualities, exceptional early season color, and greater Brix to acid ratios. These cultivars are variously referred to herein by the general terms “early season cultivars” or “very early season cultivars.” It will be understood that these terms exclude Hamlin round orange varieties which, although an early season fruit, do not possess the other properties of these very early season cultivars.

With more particular reference to these very early season cultivars, they exhibit early season color which is more intense than the early season color of juice extracted from Hamlin round oranges, particularly during the early harvest season months of October and November. The juice from these very early season cultivars also exhibits the minimum total solids weight percentages (or minimum Brix values) which are in excess of those provided by juice from Hamlin round oranges. Typically, these very early season cultivars satisfy Brix to acid ratio (BAR) requirements of the State of Florida Department of Agriculture at a time in the harvest season prior to that at which such standard is achieved by Hamlin round orange cultivars. It will be appreciated that Brix is a well-recognized parameter by which the quality of fruits including citrus fruits such as oranges is measured. A Brix measurement is a minimum total solids percentage by weight, which is at times loosely equated to sweetness or sugars present in the fruit. It is also generally appreciated that the acid in the Brix to acid ratio is citric acid.

As an example of the citrus fruit maturity requirements of the Florida Department of Agriculture and Consumer Services, orange standards of this agency for a particular recent growing season were as follows. For oranges harvested between August 1 and October 31, the minimum total solids are permitted vary between 9.0° Brix and below 11.0° Brix. Furthermore, these State of Florida specifications specify that a corresponding minimum BAR must be met for each Brix value within this range. Different standards apply for different stages of the year. More particularly, the standards referred to herein are in accordance with the following Table I.

TABLE I
ROUND ORANGE MATURITY CHART

| | |
|---|---|
| Brix | BAR |

August 1-October 31

| | |
|---|---|
| 9.0 to not including 9.1 | 10.00 to 1 |
| 9.1 to not including 9.2 | 9.95 to 1 |
| 9.2 to not including 9.3 | 9.90 to 1 |
| 9.3 to not including 9.4 | 9.85 to 1 |
| 9.4 to not including 9.5 | 9.80 to 1 |
| 9.5 to not including 9.6 | 9.75 to 1 |
| 9.6 to not including 9.7 | 9.70 to 1 |
| 9.7 to not including 9.8 | 9.65 to 1 |
| 9.8 to not including 9.9 | 9.60 to 1 |
| 9.9 to not including 10.0 | 9.55 to 1 |
| 10.0 to not including 10.1 | 9.50 to 1 |
| 10.1 to not including 10.2 | 9.45 to 1 |
| 10.2 to not including 10.3 | 9.40 to 1 |
| 10.3 to not including 10.4 | 9.35 to 1 |
| 10.4 to not including 10.5 | 9.30 to 1 |
| 10.5 to not including 10.6 | 9.25 to 1 |
| 10.6 to not including 10.7 | 9.20 to 1 |
| 10.7 to not including 10.8 | 9.15 to 1 |
| 10.8 to not including 10.9 | 9.10 to 1 |
| 10.9 to not including 11.0 | 9.05 to 1 |

November 1-November 15

| | |
|---|---|
| 8.7 to not including 8.8 | 10.15 to 1 |
| 8.8 to not including 8.9 | 10.10 to 1 |
| 8.9 to not including 9.0 | 10.05 to 1 |

November 16-November 30

| | |
|---|---|
| 8.5 to not including 8.6 | 10.25 to 1 |
| 8.6 to not including 8.7 | 10.20 to 1 |

December 1-July 31

| | |
|---|---|
| 8.0 to not including 8.1 | 10.50 to 1 |
| 8.1 to not including 8.2 | 10.45 to 1 |
| 8.2 to not including 8.3 | 10.40 to 1 |
| 8.3 to not including 8.4 | 10.35 to 1 |
| 8.4 to not including 8.5 | 10.30 to 1 |

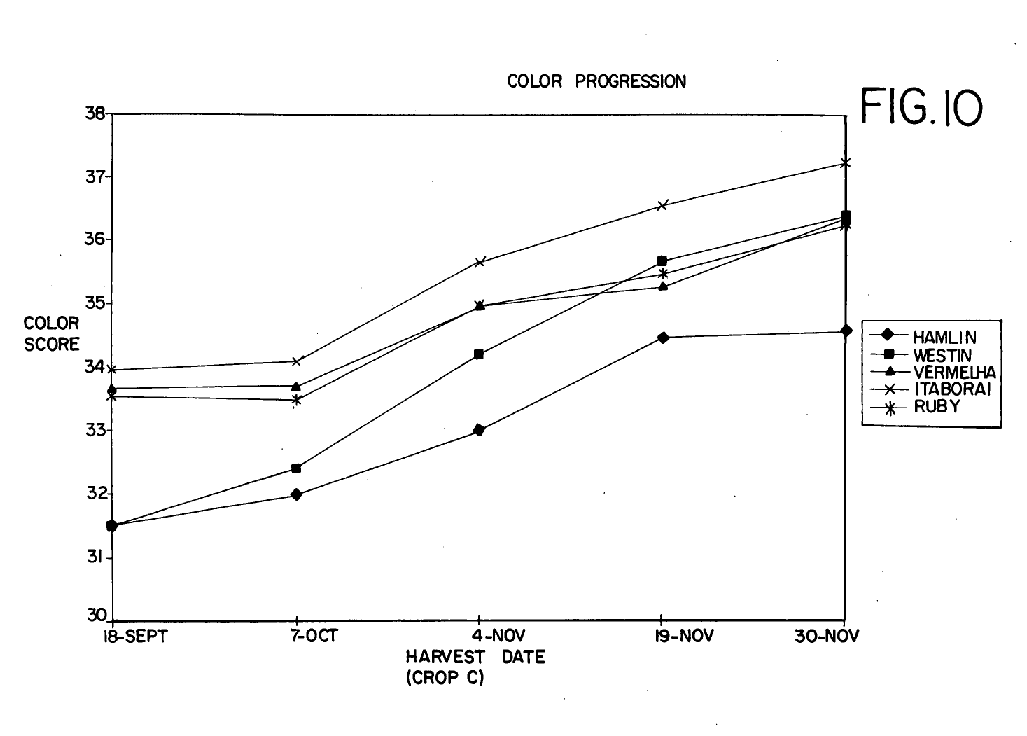

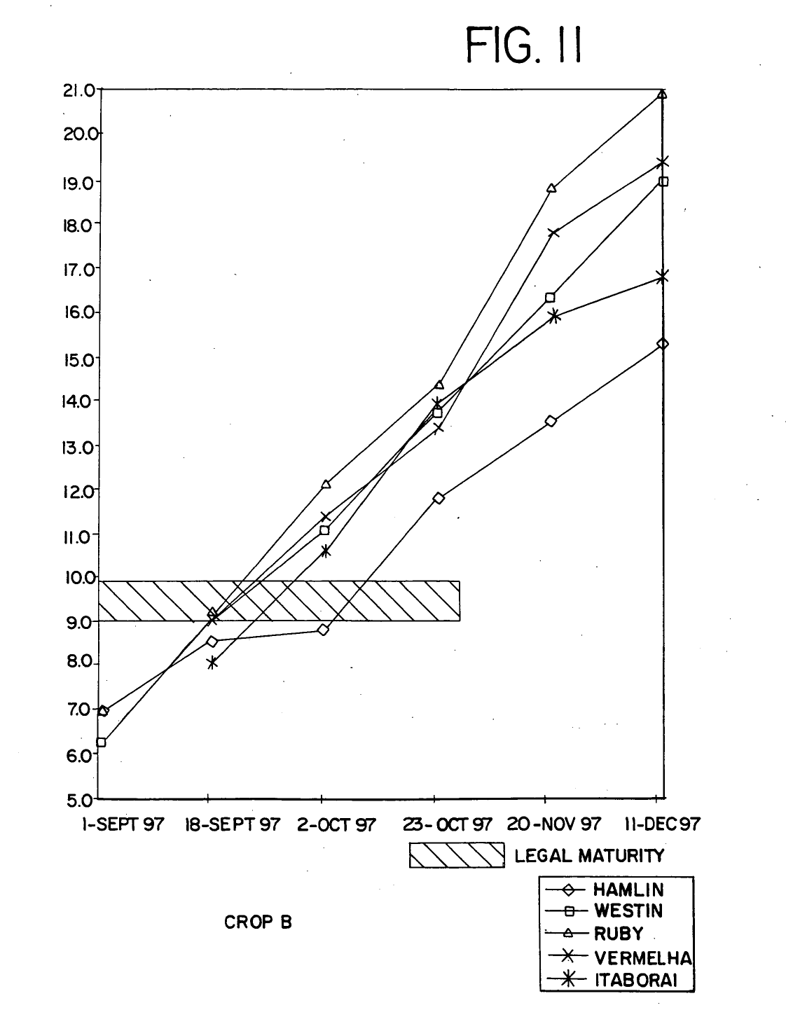

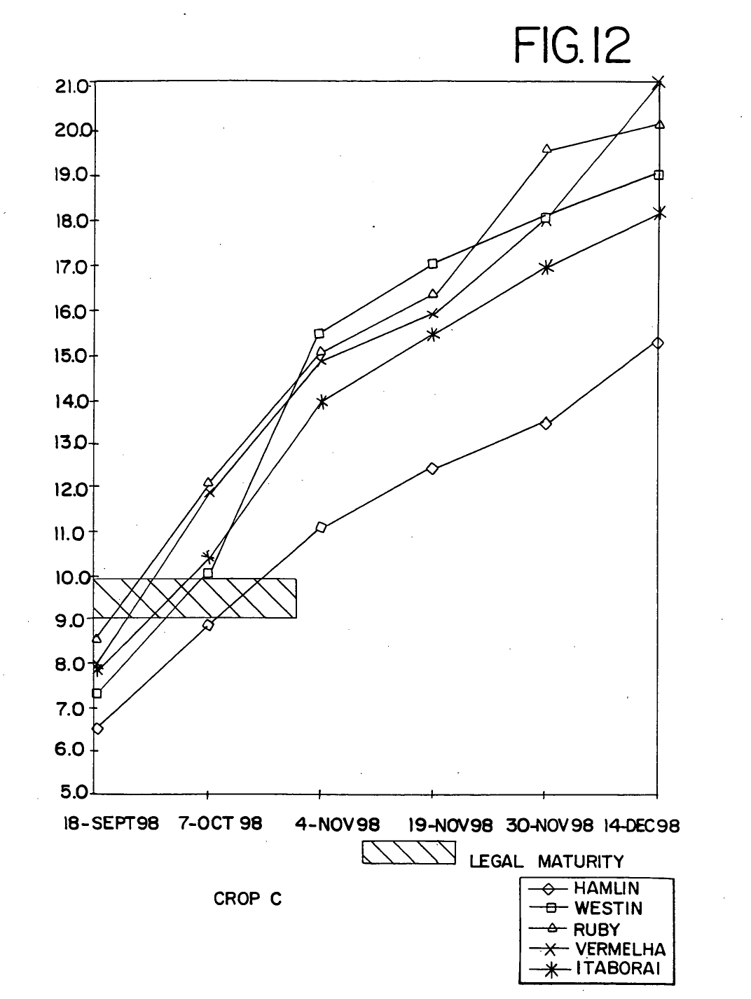

The very early season cultivars meet or exceed the round orange standards as noted in Table I, typically at a date earlier than they are met by Hamlin round oranges. This is illustrated in FIG. 11 and FIG. 12, discussed in Examples 2 and 3.

These very early season cultivars typically are within the Seleta family of cultivars. Juices from one or a combination of these cultivars are included. Examples of members of the Seleta family of cultivars include Seleta Branca, Seleta Coroa-do-Rei, Seleta de Itaborai and Seleta Vermelha. Also included for not from concentrate juice products are a Ruby Nucellar cultivar and a Westin cultivar. Preferred very early season cultivars for not from concentrate products are Seleta de Itaborai, Ruby Nucellar and Westin. The Seleta Vermelha early season cultivar is at times identified under the name “Earlygold”. It remains within the Seleta family of round orange cultivars.

It will be appreciated that large-scale commercial production of not from concentrate orange juice typically includes a blend operation. For example, in the fall of the year in the Northern Hemisphere, stored juice supplies are blended with early season fresh juice in order to provide the not from concentrate orange juice which is filled into cartons for distribution and consumption by the consumer. Typically, in the early months of the fresh juice harvest season, this fresh juice supply is from Hamlin round oranges. Hamlin round oranges have a peak harvest season between about mid-October and March. The very early season cultivars have a significantly earlier peak harvest season, namely from September through November. The very early season cultivars also exhibit relatively high Color Numbers during their peak harvest season. Typically, the maximum Color Numbers achieved by the very early season cultivars during this peak harvest season are higher than the maximum Color Numbers achieved by Hamlin oranges during the same respective time periods. For example, during this time frame, the juice from Hamlin round oranges has a peak color number of about 32 CN. The early season cultivars have a higher color number, typically at least 33 CN and above at a comparable time of the year.

Within the context of commercial production of not from concentrate orange juice during this early season time frame, a typical target Color Number for the in-carton not from concentrate orange juice is at least 36 CN. It will be appreciated that, because such production is dependent upon naturally occurring juice sources which have not been concentrated, this target is not always strictly met and at times can be between 35 CN to about 37 CN, especially within this early season time frame. It will be further appreciated that the freshly squeezed juice, especially within this early season time frame, is blended with stored juice, such as that which has been frozen as whole juice or stored as whole juice. In a production within which only Hamlin juice sources having a maximum Color Number of 32 CN are used as the fresh juice component of the not from concentrate blend, a greater proportion of stored juice is required than when the fresh juice component is from one of the very early season cultivars, if the target Color Number is to be achieved by the not from concentrate blend.

Advantageously, the higher early season Color Number values which are characteristic of the very early season cultivars of the invention will permit either a larger relative percentage of fresh juice or a cartoned product having a higher Color Number than otherwise obtainable with only Hamlin juice as the fresh juice source. Accordingly, in one aspect of the invention, the early season cultivar juice can be blended with Hamlin juice sources in order to provide an early season fresh juice source which has an increased color number. Alternatively, the early season cultivars can be the sole source of the fresh juice going into the cartoned blend.

Importantly, uses of the very early season cultivars in preparing not from concentrate orange juice products is made even more advantageous because of other properties of these early season cultivars. These early season cultivars achieve a BAR level which satisfies regulatory requirements for fruit maturity at a time which is earlier in the growing season than traditional early season cultivars such as Hamlin round oranges. This facilitates the ability of the fresh juice to meet governmental regulations and to provide a product which is more likely to satisfy consumer standards as well.

Additionally, juices prepared from the early season cultivars exhibit sensory evaluation results which are in most respects detectably superior to those of Hamlin round orange juices. The sensory superiority of the very early season cultivars is illustrated when their juices are blended with Hamlin juice. Blends at many various levels are possible. Practically, blends having between about 5 and about 70 volume percent of the total volume of the blended juice product will be practiced, typically between about 5 and about 40 volume percent. Ideal volume ratios will vary somewhat for different ones of the very early season cultivars. For some very early season cultivars, a more desirable amount is between about 30 and about 70 volume percent within the blend.

Objective sensory qualities are expressed in terms of several specific sensory characteristics which are identifiable by trained sensory panels. Surprisingly, descriptive sensory analyses have shown that addition of very early season cultivars made favorable quality improvements to early season Hamlin juice. Overall trends in this regard include reduced green character, bitterness and chemical notes, as well as trends toward increased raw and total orange flavors.

Exemplary illustrations of the disclosure herein are provided in the following examples.

### EXAMPLE 1

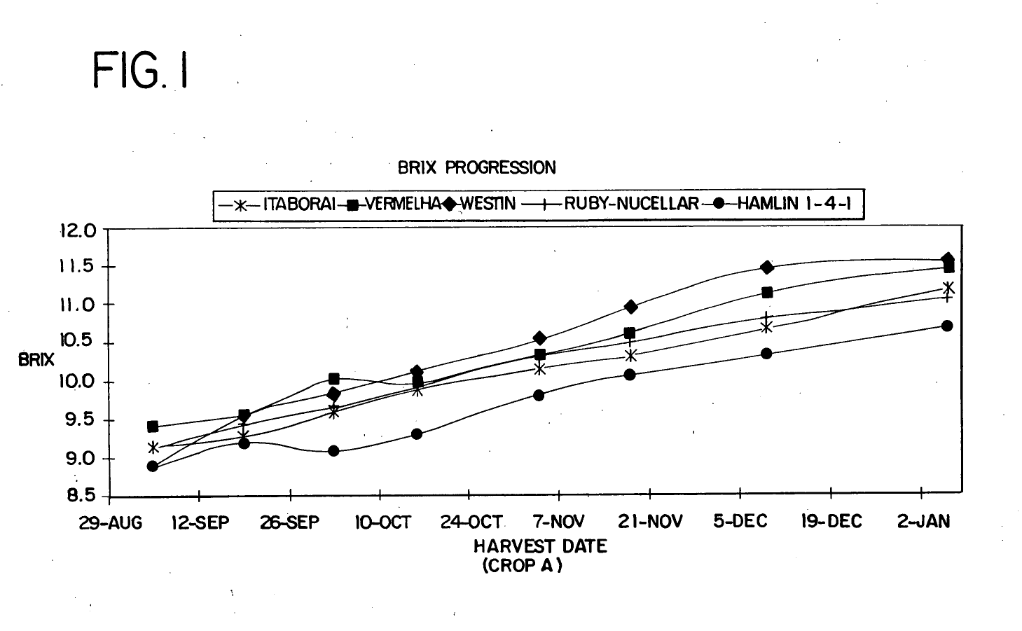

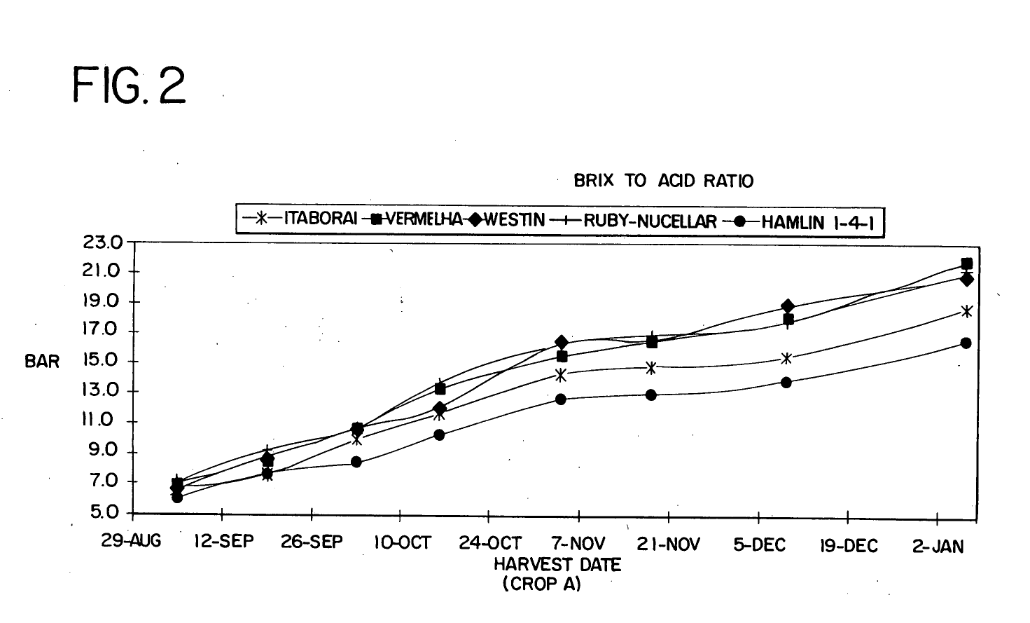

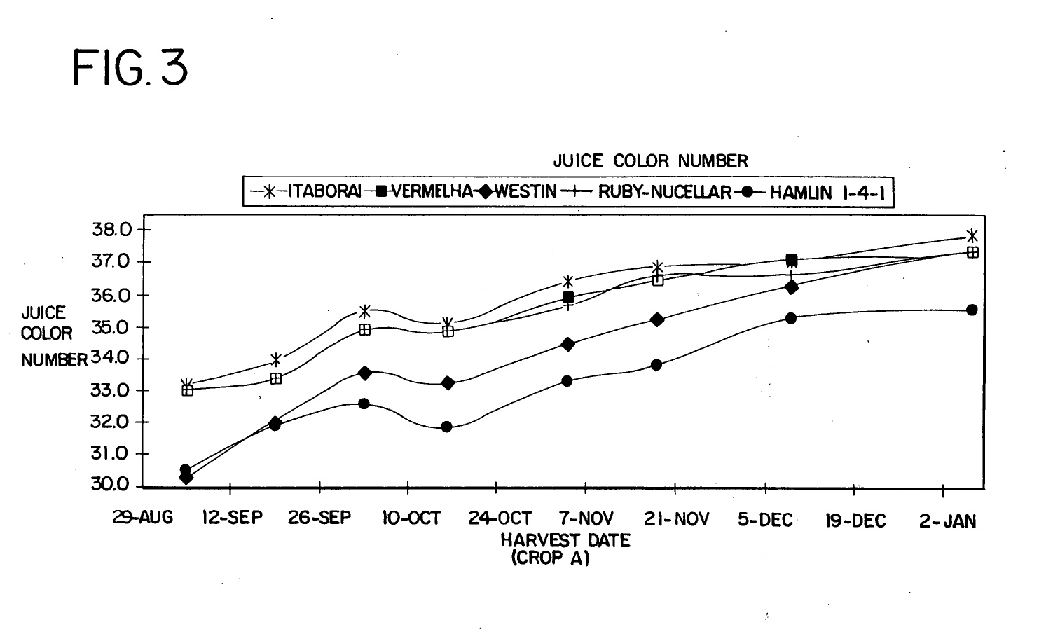

Quantities of each of five different round orange cultivars were harvested on several different dates between September and January during the same growing season. Juice was recovered from each group of cultivars or each harvest date. Each juice was analyzed for the following: Brix as Brix, acid as weight percent citric acid, color as Color Number; oil as weight percent d-limonene; and vitamin C in mg/1000 ml of juice. These are identified as Crop A results. The data are reported in Table II. In addition, the Brix, BAR and Color Number data are plotted in FIG. 1, FIG. 2 and FIG. 3, respectively.

TABLE II
(CROP A)

| | | | Acid | | Color | | |
|---|---|---|---|---|---|---|---|
| VARIETY | DATE | Brix | (% wt) | BAR | (CV) | Oil | Vitamin C |
| Hamlin | 05-Sept | 8.90 | 1.46 | 5.97 | 30.50 | 0.032 | 51.26 |
| | 19-Sept | 9.22 | 1.20 | 7.71 | 31.88 | 0.019 | 54.55 |
| | 03-Oct | 9.09 | 1.09 | 8.41 | 32.58 | 0.020 | 50.42 |
| | 16-Oct | 9.31 | 0.92 | 10.25 | 31.85 | 0.004 | 50.81 |
| | 06-Nov | 9.80 | 0.78 | 12.64 | 33.30 | 0.004 | 51.28 |
| | 18-Nov | 10.06 | 0.77 | 13.02 | 33.83 | 0.004 | 48.16 |
| | 09-Dec | 10.33 | 0.74 | 13.90 | 35.30 | 0.004 | 47.00 |
| | 06-Jan | 10.68 | 0.64 | 16.64 | 35.62 | 0.005 | 48.96 |
| Westin | 05-Sept | 8.90 | 1.35 | 6.58 | 30.23 | 0.044 | 43.65 |
| | 19-Sept | 9.55 | 1.09 | 8.79 | 32.03 | 0.031 | 44.51 |
| | 03-Oct | 9.85 | 0.93 | 10.62 | 33.57 | 0.024 | 41.52 |
| | 16-Oct | 10.10 | 0.85 | 12.07 | 33.23 | 0.003 | 39.67 |
| | 06-Nov | 10.53 | 0.65 | 16.38 | 34.47 | 0.002 | 40.23 |
| | 18-Nov | 10.93 | 0.66 | 16.67 | 35.23 | 0.003 | 40.92 |
| | 09-Dec | 11.46 | 0.61 | 18.96 | 36.30 | 0.004 | 39.03 |
| | 06-Jan | 11.58 | 0.55 | 21.07 | 37.37 | 0.003 | 38.67 |
| Ruby- | 05-Sept | 9.13 | 1.28 | 7.12 | 33.02 | 0.064 | 41.67 |
| Nucellar | 19-Sept | 9.43 | 1.03 | 9.18 | 33.40 | 0.070 | 40.38 |
| | 03-Oct | 9.66 | 0.91 | 10.73 | 34.92 | 0.065 | 42.98 |
| | 16-Oct | 9.92 | 0.73 | 13.66 | 34.88 | 0.008 | 39.19 |
| | 06-Nov | 10.30 | 0.63 | 16.45 | 35.65 | 0.006 | 38.21 |
| | 18-Nov | 10.50 | 0.62 | 16.94 | 36.58 | 0.009 | 37.66 |
| | 09-Dec | 10.80 | 0.60 | 17.95 | 36.62 | 0.011 | 36.02 |
| | 06-Jan | 11.06 | 0.52 | 21.32 | 37.38 | 0.011 | 35.12 |
| Vermelha | 05-Sept | 9.42 | 1.36 | 6.96 | 33.02 | 0.077 | 44.19 |
| (Earlygold) | 19-Sept | 9.57 | 1.12 | 8.62 | 33.38 | 0.064 | 44.63 |
| | 03-Oct | 10.02 | 0.95 | 10.66 | 34.92 | 0.051 | 43.23 |
| | 16-Oct | 9.98 | 0.76 | 13.28 | 34.83 | 0.010 | 41.64 |
| | 06-Nov | 10.34 | 0.67 | 15.52 | 35.90 | 0.006 | 41.17 |
| | 18-Nov | 10.60 | 0.65 | 16.44 | 36.45 | 0.008 | 40.05 |
| | 09-Dec | 11.13 | 0.62 | 18.11 | 37.10 | 0.010 | 39.64 |
| | 06-Jan | 11.46 | 0.53 | 21.83 | 37.30 | 0.013 | 40.58 |
| Itaborai | 05-Sept | 9.15 | 1.39 | 6.62 | 33.17 | 0.066 | 41.29 |
| | 19-Sept | 9.30 | 1.23 | 7.62 | 33.98 | 0.060 | 40.92 |
| | 03-Oct | 9.60 | 0.98 | 9.90 | 35.50 | 0.052 | 39.70 |
| | 16-Oct | 9.88 | 0.85 | 11.68 | 35.10 | 0.008 | 38.65 |
| | 06-Nov | 10.14 | 0.71 | 14.31 | 36.40 | 0.006 | 36.80 |
| | 18-Nov | 10.32 | 0.70 | 14.83 | 36.85 | 0.007 | 36.75 |
| | 09-Dec | 10.66 | 0.69 | 15.56 | 37.05 | 0.011 | 34.73 |
| | 06-Jan | 11.19 | 0.60 | 18.84 | 37.90 | 0.010 | 33.64 |

From FIG. 1, it will be noted that each of the very early season cultivars exhibited Brix values equal to or greater than that of the Hamlin round oranges. This is especially evident in the general October time frame. Similar observations can be made with respect to the BAR data reported in FIG. 2. FIG. 3 shows that, with the exception of very early harvests, the juice Color Number is higher for each of the very early season cultivars than for the Hamlin juice. In general, this difference is about one Color Number or greater. This important advantageous effect is especially evident in the general October and November time frame, which is important for early season fresh juice supplies.

### EXAMPLE 2

Additional pieces of fruit from the round orange cultivars of Example 1 are categorized as Crop B fruit. Extraction and analysis were carried out, results being reported in Table III.

TABLE III
(CROP B)

| | | | | | | | VIT |
|---|---|---|---|---|---|---|---|
| VARIETY | DATE | BRIX | ACID | BAR | COLOR | OIL | C |
| HAMLIN | 01-Sept | 9.47 | 1.34 | 7.07 | 30.80 | 0.006 | 64.31 |
| | 15-Sept | 9.11 | 1.06 | 8.64 | 31.40 | 0.005 | 53.24 |
| | 02-Oct | 8.73 | 1.01 | 8.85 | 32.53 | 0.010 | 47.86 |
| | 23-Oct | 9.53 | 0.80 | 11.96 | 33.03 | 0.004 | 49.44 |
| | 20-Nov | 10.29 | 0.76 | 13.56 | 33.90 | 0.005 | 39.05 |
| | 11-Dec | 10.40 | 0.68 | 15.38 | 35.13 | 0.005 | 49.81 |
| WESTIN | 01-Sept | 9.29 | 1.45 | 6.41 | 31.40 | 0.002 | 47.73 |
| | 15-Sept | 9.15 | 1.01 | 9.16 | 31.80 | 0.005 | 47.90 |
| | 02-Oct | 9.40 | 0.85 | 11.12 | 33.53 | 0.004 | 42.78 |
| | 23-Oct | 9.98 | 0.73 | 13.82 | 34.53 | 0.004 | 41.75 |
| | 20-Nov | 10.90 | 0.67 | 16.45 | 35.63 | 0.004 | 39.48 |
| | 11-Dec | 11.19 | 0.59 | 19.07 | 37.40 | 0.005 | 42.01 |
| RUBY | 15-Sept | 8.08 | 0.88 | 9.24 | 33.15 | 0.011 | 36.44 |
| | 02-Oct | 8.61 | 0.50 | 12.20 | 34.73 | 0.009 | 36.89 |
| | 23-Oct | 9.33 | 0.65 | 14.47 | 34.77 | 0.007 | 35.52 |
| | 20-Nov | 10.17 | 0.54 | 18.77 | 35.60 | 0.008 | 30.46 |
| | 11-Dec | 10.03 | 0.48 | 21.16 | 36.00 | 0.011 | 34.73 |
| VERMELHA | 15-Sept | 8.80 | 0.98 | 9.02 | 33.50 | 0.008 | 41.72 |
| (Earlygold) | 02-Oct | 9.23 | 0.81 | 11.44 | 34.93 | 0.010 | 41.66 |
| | 23-Oct | 9.98 | 0.75 | 13.32 | 35.33 | 0.010 | 41.81 |
| | 20-Nov | 10.86 | 0.62 | 17.76 | 36.27 | 0.010 | 42.06 |
| | 11-Dec | 11.32 | 0.59 | 19.43 | 37.17 | 0.013 | 42.90 |
| ITABORAI | 15-Sept | 8.41 | 1.05 | 8.08 | 33.40 | 0.008 | 36.21 |
| | 02-Oct | 9.00 | 0.85 | 10.67 | 34.90 | 0.007 | 37.66 |
| | 23-Oct | 9.74 | 0.71 | 13.83 | 35.60 | 0.008 | 37.14 |
| | 20-Nov | 10.30 | 0.65 | 15.95 | 36.67 | 0.008 | 32.40 |
| | 11-Dec | 10.56 | 0.64 | 16.70 | 37.30 | 0.012 | 34.98 |

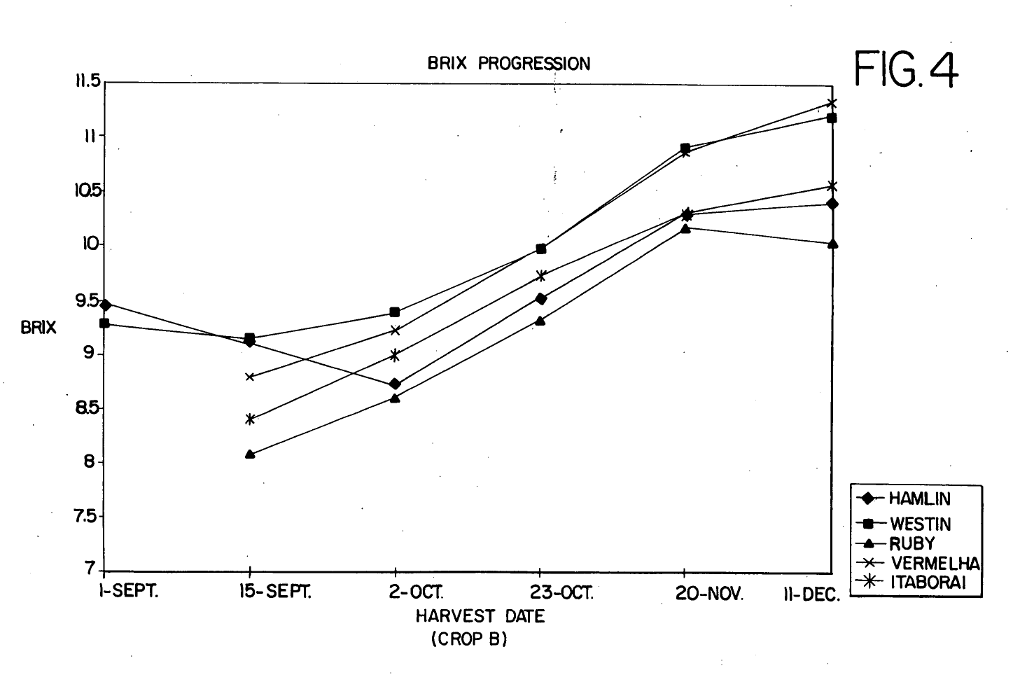

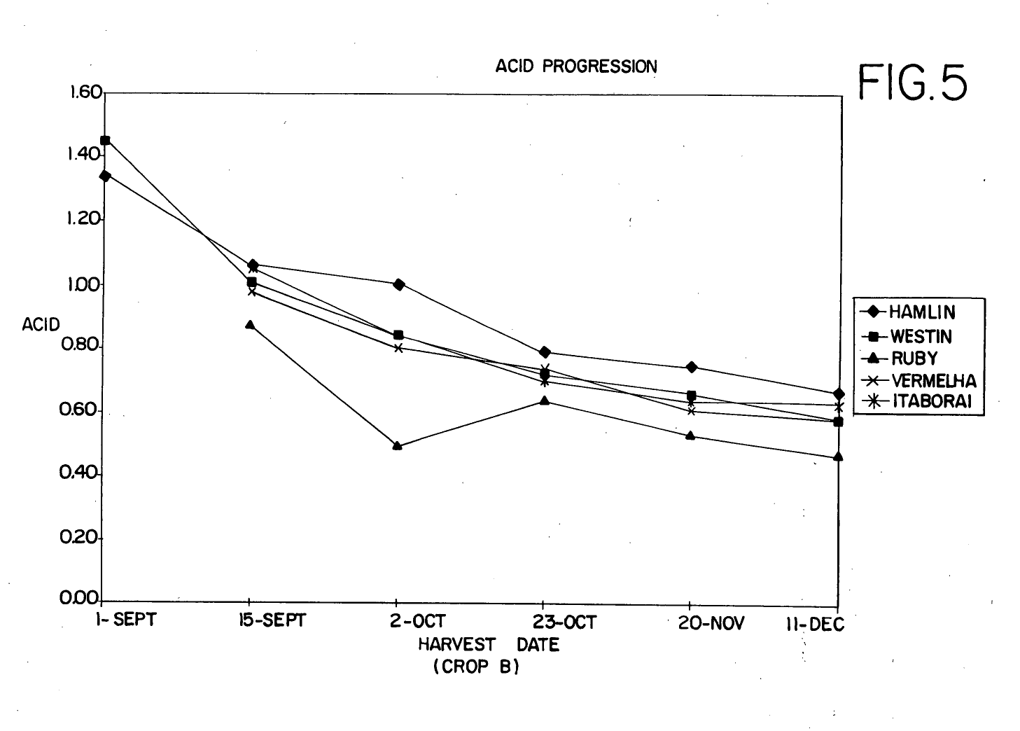

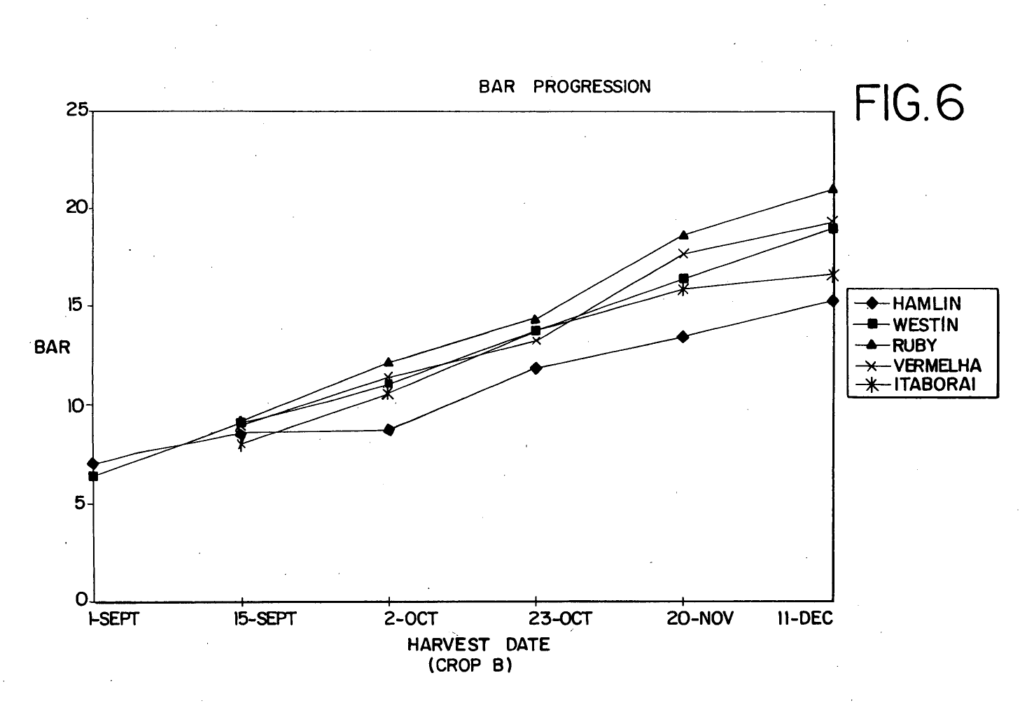

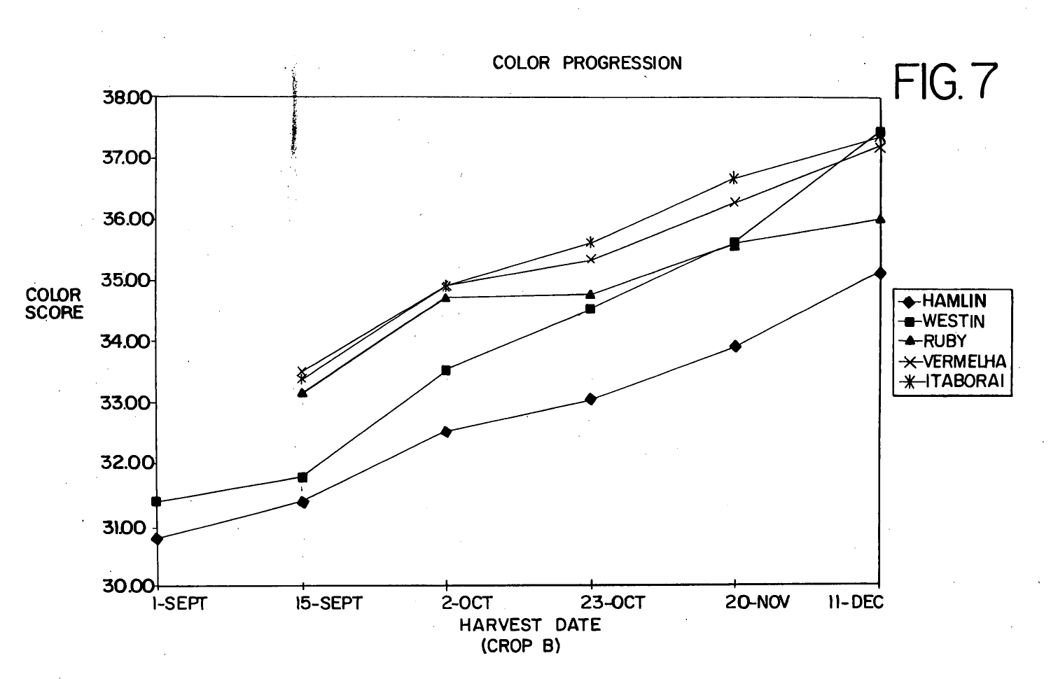

Certain of these data are plotted as follows. FIG. 4 shows Brix values. FIG. 5 shows citric acid percentage. FIG. 6 shows BAR values, and FIG. 7 shows the Color Number data. In the October and November time frames, FIG. 4 shows that the Brix value for each of the very early season cultivars is about the same as or greater than that for the Hamlin fruit. As is evident from FIG. 5, the acid percentage is similar for each of the five cultivars, except for the Ruby Nucellar cultivar, especially in the October time frame, although the BAR data illustrated in FIG. 6 show that the BAR data for the Ruby Nucellar is noticeably superior to that of Hamlin and about the same or somewhat better than that for the other three very early season cultivars for the Crop B results. FIG. 7 shows the Color Number advantage of the very early season cultivars when compared with Hamlin juice of this Crop B testing. In the October and November time frame, the very early season cultivars have a Color Number advantage of at least 1 over the Hamlin juice. In some instances, the Color Number advantage is 2 CV or more.

FIG. 11 expands the scale of the BAR data plotted in. FIG. 6. Also added is the orange standard information from Table I during the earliest season time frame. It is noted that the Hamlin harvest did not achieve the orange standard for BAR until about mid-October, whereas the Itaborai harvest achieved the BAR standard in mid-to-late September, with the other three very early season cultivar harvests reaching the BAR standard by mid-September for this Crop B fruit.

### EXAMPLE 3

Crop C data for these same five cultivars are reported in Table IV.

TABLE IV
(CROP C)

| | | | | | | | VIT |
|---|---|---|---|---|---|---|---|
| VARIETY | DATE | BRIX | ACID | BAR | COLOR | OIL | C |
| HAMLIN | 18-Sept | 8.77 | 1.34 | 6.54 | 31.53 | — | — |
| | 07-Oct | 8.91 | 1.00 | 8.91 | 32.00 | 0.004 | 48.60 |
| | 04-Nov | 9.65 | 0.86 | 11.23 | 33.03 | 0.005 | 48.82 |
| | 19-Nov | 10.18 | 0.83 | 12.41 | 34.5 | — | 47.42 |
| | 30-Nov | 10.4 | 0.79 | 13.39 | 34.60 | 0.004 | 48.33 |
| | 14-Dec | 10.94 | 0.72 | 15.3 | 35.5 | 0.003 | 45.17 |
| WESTIN | 18-Sept | 8.81 | 1.21 | 7.32 | 31.50 | — | — |
| | 07-Oct | 8.95 | 0.90 | 10.07 | 32.43 | 0.003 | 38.15 |
| | 04-Nov | 10.64 | 0.69 | 15.48 | 34.23 | 0.004 | 42.42 |
| | 19-Nov | 10.97 | 0.64 | 17.14 | 35.70 | — | 49.45 |
| | 30-Nov | 11.44 | 0.62 | 18.46 | 36.40 | 0.005 | 38.47 |
| | 14-Dec | 11.51 | 0.6 | 19.15 | 36.70 | 0.004 | 35.22 |
| RUBY | 18-Sept | 8.84 | 1.04 | 8.55 | 33.57 | — | — |
| | 07-Oct | 9.23 | 0.76 | 12.18 | 33.50 | 0.007 | 36.32 |
| | 04-Nov | 10.06 | 0.67 | 15.18 | 34.97 | 0.009 | 36.13 |
| | 19-Nov | 10.63 | 0.65 | 16.28 | 35.50 | — | 36.6 |
| | 30-Nov | 11.15 | 0.57 | 19.64 | 36.27 | 0.017 | 37.99 |
| | 14-Dec | 11.67 | 0.58 | 20.14 | 35.17 | 0.013 | 33.67 |
| VERMELHA | 18-Sept | 9.45 | 1.18 | 8.01 | 33.67 | — | — |
| (Earlygold) | 07-Oct | 9.84 | 0.83 | 11.81 | 33.70 | 0.008 | 43.31 |
| | 04-Nov | 10.39 | 0.70 | 14.82 | 34.97 | 0.008 | 43.12 |
| | 19-Nov | 11.43 | 0.74 | 15.86 | 35.30 | — | 39.59 |
| | 30-Nov | 11.57 | 0.64 | 18.16 | 36.37 | 0.013 | 44.52 |
| | 14-Dec | 12.12 | 0.57 | 21.15 | 35.63 | 0.014 | 40.90 |
| ITABORAI | 18-Sept | 9.03 | 0.14 | 7.94 | 33.97 | — | — |
| | 07-Oct | 9.33 | 0.89 | 10.47 | 34.10 | 0.009 | 36.16 |
| | 04-Nov | 10.16 | 0.73 | 13.99 | 35.67 | 0.008 | 35.25 |
| | 19-Nov | 10.85 | 0.71 | 15.39 | 36.57 | — | 39.59 |
| | 30-Nov | 11.11 | 0.66 | 16.86 | 37.27 | 0.012 | 35.73 |
| | 14-Dec | 11.61 | 0.64 | 18.19 | 36.33 | 0.011 | 32.42 |

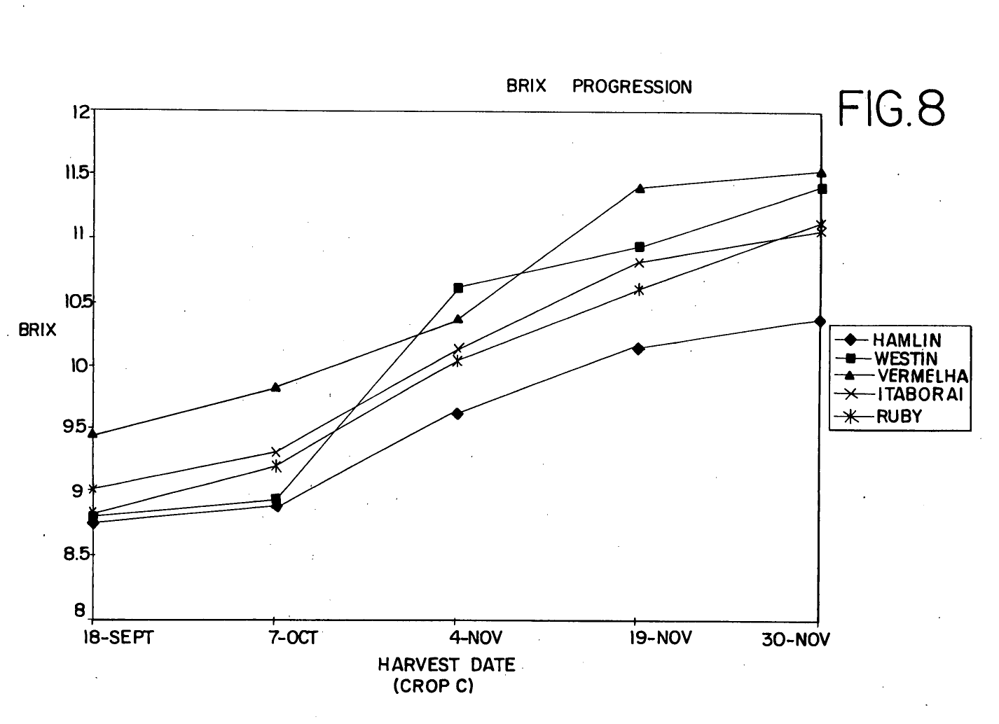

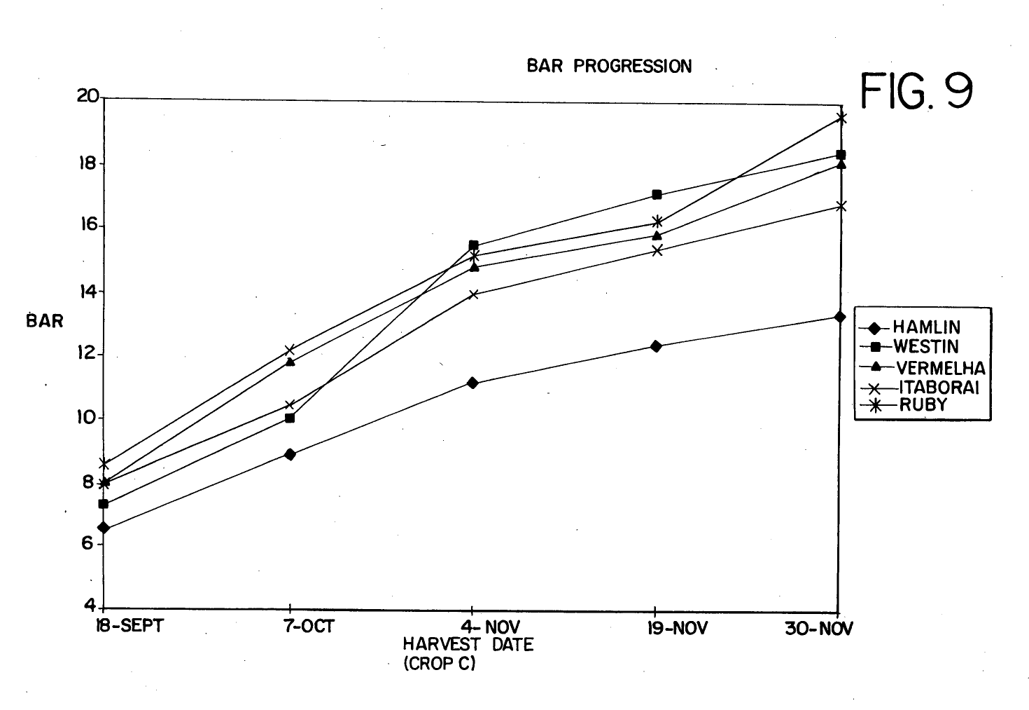

FIG. 8 shows Brix data from Table IV, which indicates that each of the four very early season cultivars had Brix properties equal to or superior to those of the Hamlin fruit. FIG. 9 shows BAR data for the Crop C fruit, with the four very early season cultivars having higher BAR values than the Hamlin fruit. FIG. 10 shows that the Color Value for the Hamlin juice is noticeably less than that for the other Crop C juice. With a few exceptions, this advantage of the early season cultivars is 1 CV or greater.

FIG. 12 is similar to FIG. 11 for Crop C data. The Hamlin harvest did not achieve the BAR orange standard until mid-October, whereas the Westin and Ruby Nucellar harvests achieved this BAR standard in late-September and the Seleta harvests achieved this BAR standard in mid-to-late September.

### EXAMPLE 4

Sensory evaluations were made for Crop A, Crop B and Crop C. Trained sensory panel ratings were made for various characteristics of the juice from each of the five cultivars Hamlin, Westin, Ruby Nucellar, Vermelha and Itaborai. The descriptive sensory analyses were made in terms in accordance with the following terms: Orange component consisted of two categories, namely orange raw and orange peel oil. Other citrus ranged between lemon lime or grapefruit (one end of this scale) to tangerine (at the other end of this scale), the middle of the scale being orange. Other fruit notes were detected when present, with orange in the middle of this scale. Sweet, sour and bitter notes were reported. Another sensory analysis was for other aromatics, the comments associated with this sensory analysis parameter ranging from “green, sulfur” (at one undesirable end of the scale) to “painty” (at the other undesirable end of the scale). The middle, most desirable section of this scale is denoted as floral.

Also generated were “overall quality” scores. Each overall quality score is on a scale of −2 to +2. For early season fresh juice supplies to be blended with stored juice, an overall quality score which is closer to zero, but not necessarily positive, is an acceptable overall quality score. This is due in part because the stored juice typically has an overall quality score of about zero or above.

Results from Crops A, B and C were averaged for fruit harvested in October, the sensory evaluations having taken place between about October 15 and November 1. This average overall quality score for the Hamlin, Westin and Ruby Nucellar varieties was −1.2. For Seleta de Itaborai and Seleta Vermelha, the average overall quality score was −1.1.

Average overall quality scores for November were also determined for a period between about November 1 and November 20. For the Hamlin and Seleta de Itaborai varieties, the average overall quality score was −0.7. For Seleta Vermelha, the average overall quality score was −0.8. For the Ruby Nucellar variety, the average overall quality score was −0.6, and for the Westin variety, the average overall quality score was −0.5.

These data show that, for sensory evaluations carried out on October and November harvests, the early variety cultivars have overall quality scores which are better than or comparable to those of the Hamlin variety. This indicates that substitution of any of these four very early season varieties for some or all of Hamlin freshly squeezed juice in a not from concentrate orange juice product will enhance and not detrimentally impact the sensory evaluation or taste of the not from concentrate orange juice.

### EXAMPLE 5

Pieces of fruit harvested in early-to-mid October in the Northern Hemisphere were used in making base juices and juice blends. These are identified as Crop D fruit. Juice quality analyses for each of the five base juices are reported in Table V.

TABLE V
(CROP D)

| | | | | | | | VIT |
|---|---|---|---|---|---|---|---|
| VARIETY | DATE | BRIX | ACID | BAR | COLOR | OIL | C |
| HAMLIN | 14-Oct | 8.63 | 0.91 | 9.48 | 33.7 | 0.004 | 44.02 |
| WESTIN | 14-Oct | 9.07 | 0.86 | 10.55 | 34.6 | 0.004 | 35.17 |
| RUBY | 14-Oct | 8.84 | 0.71 | 12.45 | 35.5 | 0.009 | 35.14 |
| VERMELHA | 14-Oct | 9.64 | 0.80 | 12.05 | 35.3 | 0.009 | 40.80 |
| (Earlygold) | | | | | | | |
| ITABORAI | 14-Oct | 9.37 | 0.87 | 10.77 | 35.8 | 0.012 | 37.90 |

Juice quality analyses for blends of these five juices are found in Table VI. The blends are of Hamlin juice with 0 volume percent of the other cultivars or with 10 volume percent, 30 volume percent, or 60 volume percent of each one of the very early season cultivars.

TABLE VI
(CROP D)

| | | | | | COL- | | VIT |
|---|---|---|---|---|---|---|---|
| VARIETY | DATE | BRIX | ACID | BAR | OR | OIL | C |
| HAMLIN | 14-Oct | 8.63 | 0.91 | 9.48 | 33.7 | 0.004 | 44.02 |
| 10% WESTIN | 14-Oct | 8.56 | 0.92 | 9.30 | 33.9 | — | 42.97 |
| 30% WESTIN | ″ | 8.73 | 0.92 | 9.49 | 34.0 | — | 42.72 |
| 60% WESTIN | ″ | 8.89 | 0.92 | 9.66 | 34.3 | — | 40.93 |
| 10% RUBY | ″ | 8.58 | 0.91 | 9.43 | 34.0 | — | 43.16 |
| 30% RUBY | ″ | 8.41 | 0.83 | 10.13 | 34.5 | — | 40.77 |
| 60% RUBY | ″ | 8.51 | 0.77 | 11.05 | 34.9 | — | 38.23 |
| 10% | ″ | 8.55 | 0.89 | 9.61 | 34.1 | — | 43.66 |
| EARLYGOLD | | | | | | | |
| 30% | ″ | 8.89 | 0.86 | 10.34 | 34.4 | — | 42.91 |
| EARLYGOLD | | | | | | | |
| 60% | ″ | 9.15 | 0.83 | 11.02 | 34.9 | — | 42.11 |
| EARLYGOLD | | | | | | | |
| 10% ITABORAI | ″ | 9.45 | 0.92 | 9.18 | 34.1 | — | 43.14 |
| 30% ITABORAI | ″ | 8.64 | 0.90 | 9.60 | 34.5 | — | 42.14 |
| 60% ITABORAI | ″ | 8.91 | 0.89 | 10.01 | 35.0 | — | 59.46 |

### EXAMPLE 6

The blends of Westin and Hamlin juices which are specified in Example 5 were evaluated by the sensory panel using the descriptive sensory analysis. Each blend was compared with 100% Hamlin juice as the control. The addition of the Westin juice at all blend levels was found by the panel to have a reduction in green character. For the control, the green character value was 1.2. For the 10% Westin and 90% Hamlin blend, the green character value was 0.8. This was a statistically significant difference. The P-Value was 0.04. For the blend of 30% Westin and 70% Hamlin and for the blend of 60% Westin and 40% Hamlin, the green character value in each case was 1.0. There were no significant regressions for the blends.

### EXAMPLE 7

The blends of Itaborai and Hamlin juices which are specified in Example 5 were evaluated by the sensory panel using the descriptive sensory analysis. Each blend was compared with 100% Hamlin juice as the control. The addition of the Itaborai juice at all blend levels was found by the panel to have a significant reduction in green character. For the control, the green character value was 1.4. For the 10% Itaborai and 90% Hamlin blend, the green character value was 1.1. For the blend of 30% Itaborai and 70% Hamlin, the green character value was 1.0. For the blend of 60% Itaborai and 40% Hamlin, the green character value was 1.1. Each blend had a statistically significantly lower green character when compared with the all-Hamlin control. The P-Value was 0.08. Bitterness sensory evaluations were 1.2 for the control, 1.1 for the 10% Itaborai, 1.0 for the 30% Itaborai, and 1.3 for the 60% Itaborai. Bitterness was significantly lower with 30% Itaborai juice in the blend. The P-Value was 0.03. There were no significant regressions for the blends.

### EXAMPLE 8

The blends of Ruby Nucellar and Hamlin juices which are specified in Example 5 were evaluated by the sensory panel using the descriptive sensory analysis. Each blend was compared with 100% Hamlin juice as the control.

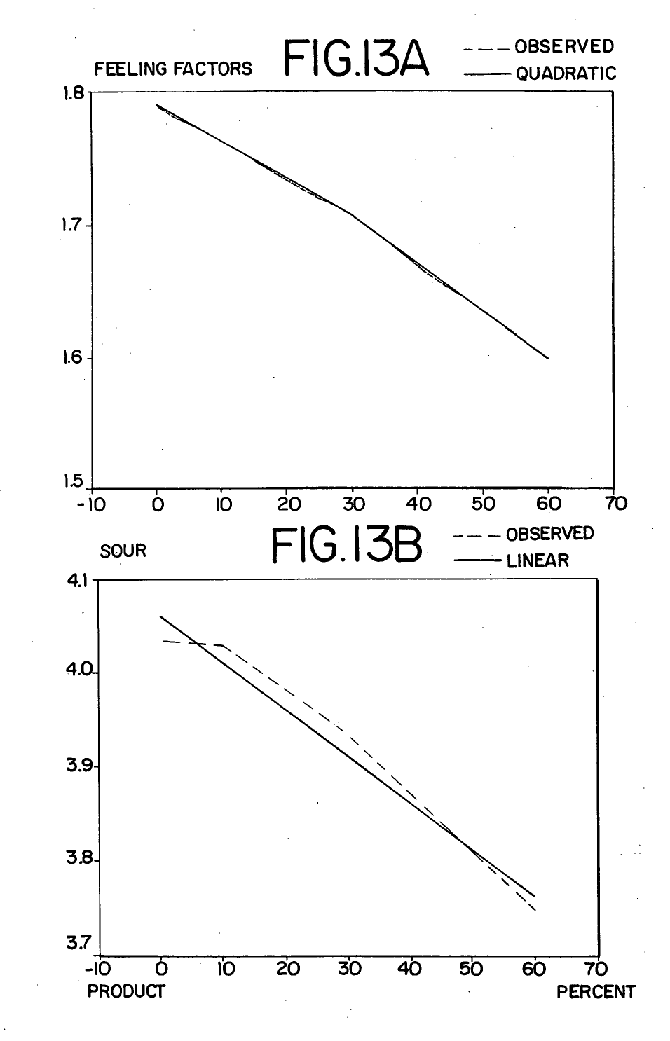

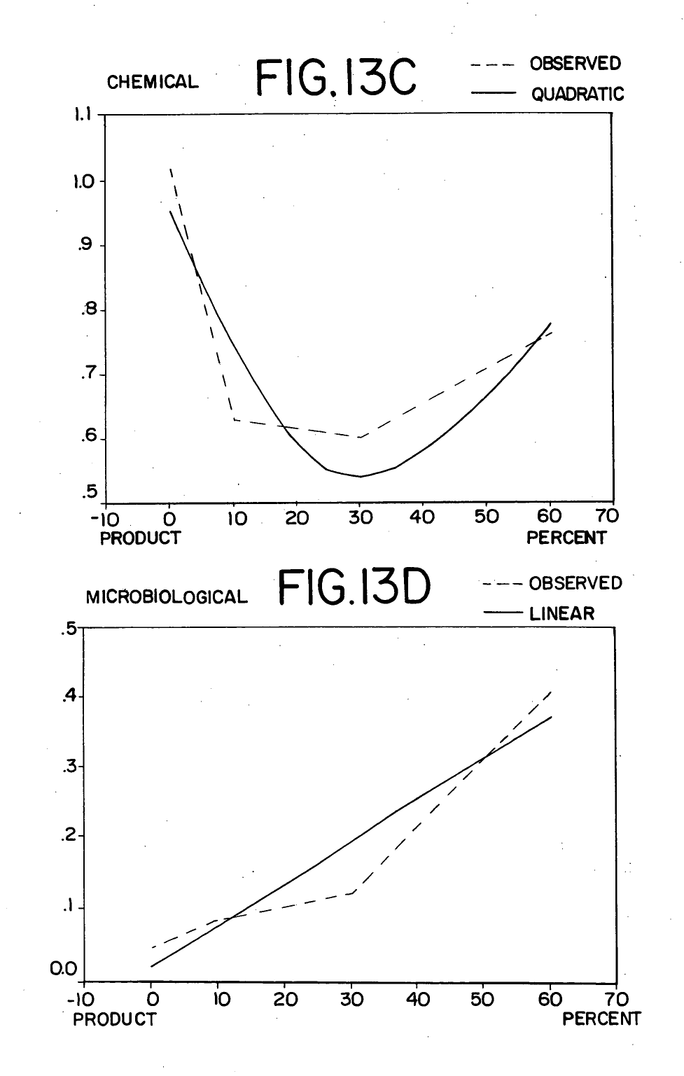

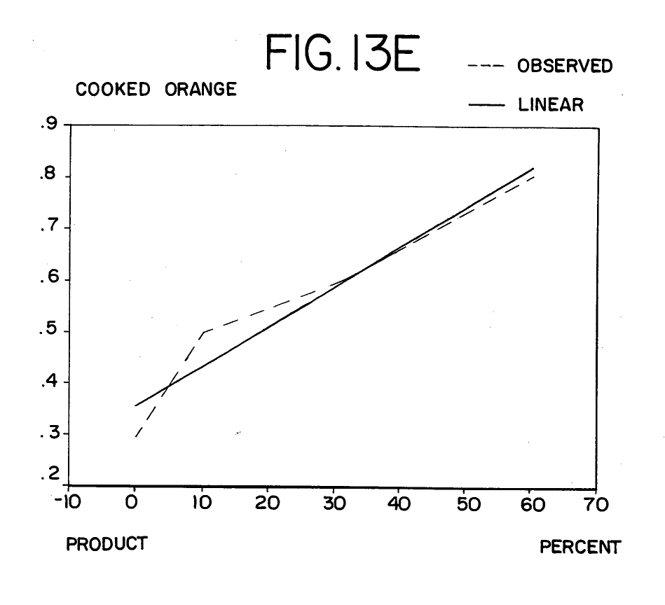

The addition of the Ruby Nucellar juice was found by the panel to decrease the feeling factors characteristic with increasing Ruby Nucellar percent, which is a desirable effect. The feeling factors values were 1.8, 1.8, 1.7 and 1.6 for the juices having 0%, 10%, 30% and 60%, respectively, of Ruby Nucellar juice, the P-Value being 0.42. Regression analysis results for these data are shown in FIG. 13A, the Observed analysis and the Quadratic analysis being substantially identical.

The addition of the Ruby Nucellar juice was found by the panel to decrease the sourness characteristic with increasing Ruby Nucellar percent, which is a desirable effect. The sourness values were 4.0, 4.0, 3.9 and 3.7 for the juices having 0%, 10%, 30% and 60%, respectively, of Ruby Nucellar juice, the P-Value being 0.41. Regression analysis results for these data are shown in FIG. 13B.

The blends with 30% and 60% Ruby Nucellar juice had a significant reduction in green character. For the control, the green character value was 1.4. For the 10% Ruby Nucellar and 90% Hamlin blend, the green character value was 1.0. For the blend of 30% Ruby Nucellar and 70% Hamlin, the green character value was 0.9. For the blend of 60% Ruby Nucellar and 40% Hamlin, the green character value was 0.8. The 30% and 60% blends each had a statistically significantly lower green character when compared with the all-Hamlin control. The P-Value was 0.02.

The blends with 10% and 30% Ruby Nucellar juice had a significant reduction in chemical notes. For the control, the chemical character value was 1.0. For the 10% Ruby Nucellar and 90% Hamlin blend, the chemical character value was 0.6. For the blend of 30% Ruby Nucellar and 70% Hamlin, the chemical character value was 0.6. For the blend of 60% Ruby Nucellar and 40% Hamlin, the chemical character value was 0.8. The 10% and 30% blends each had a statistically significantly lower green character when compared with the all-Hamlin control. The P-Value was 0.01. Results of a regression analysis of these data are plotted in FIG. 13C.

Microbiological character and cooked orange character increased with increasing percent of Ruby Nucellar juice, which indicates there may have been some spoilage in the Ruby Nucellar base juice. Regression analyses of these data are shown in FIG. 13D and FIG. 13E, respectively.

### EXAMPLE 9

The blends of Earlygold and Hamlin juices which are specified in Example 5 were evaluated by the sensory panel using the descriptive sensory analysis. Each blend was compared with 100% Hamlin juice as the control.

The addition of the Earlygold juice was found by the panel to increase the total orange characteristic with increasing Earlygold percentages, which is a desirable effect. The total orange values were 3.5, 3.5, 3.7 and 3.8 for the juices having 0%, 10%, 30% and 60%, respectively, of Earlygold juice, the P-Value being 0.10.

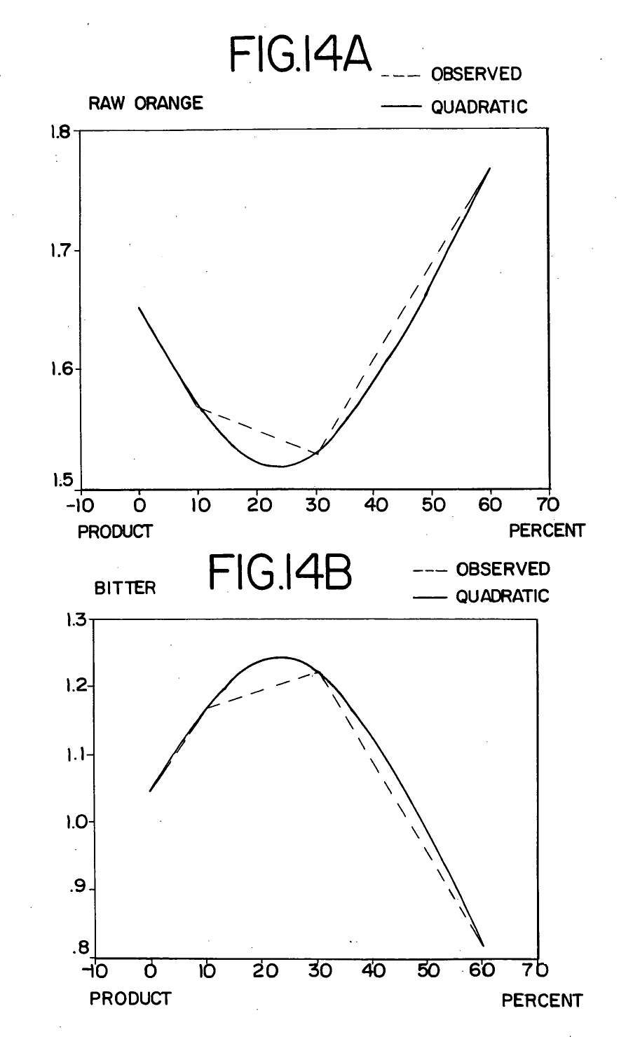

The addition of the Earlygold juice was found by the panel to decrease the raw orange (fresh orange) characteristic at 10% and 30% Earlygold, while the raw orange characteristic was found to increase at 60% Earlygold juice in the blend. The raw orange values were 1.7, 1.6, 1.5 and 1.8 for the juices having 0%, 10%, 30% and 60%, respectively, of Earlygold juice, the P-Value being 0.24. Regression analysis results for these data are shown in FIG. 14A, which indicates a positive raw orange sensory effect at somewhat less than 30% Earlygold juice in the blend.

The addition of the Earlygold juice was found by the panel to increase the bitterness characteristic at 10% and 30% Earlygold, while the bitterness characteristic was found to decrease at 60% Earlygold juice in the blend. The bitterness values were 1.0, 1.2, 1.2 and 0.8 for the juices having 0%, 10%, 30% and 60%, respectively, of Earlygold juice, the P-Value being 0.05. Regression analysis results for these data are shown in FIG. 14B, which indicates a positive bitterness sensory effect at somewhat less than 30% Earlygold juice in the blend.

It will be understood that the embodiments of the present invention which have been described are illustrative of some of the applications of the principles of the present invention. Numerous modifications may be made by those skilled in the art without departing from the true spirit and scope of the invention.

1. A method of preparing early season not from concentrate orange juice, comprising the steps of:
harvesting a very early season orange cultivar having juice with early season color of greater intensity than Hamlin orange juice while also exhibiting sensory qualities superior to the sensory qualities of Hamlin orange juice, said harvesting step including selecting a cultivar within the Seleta family of cultivars, a Westin cultivar, a Ruby Nucellar cultivar, or a combination of these very early season cultivars;
extracting juice from a volume of said very early season oranges of said harvesting step;
collecting the resulting extracted orange juice as an early season orange juice having a Color Number of at least 33 CN units; and
blending at least about 5 volume percent, based on the total volume of the orange juice, of said extracted early season orange juice with another orange juice source in order to provide a not from concentrate orange juice product having an enhanced sensory profile and a Color Number in excess of 33 CN units.

2. The method of claim 1, wherein said harvesting step occurs in October or November in the Northern Hemisphere.

3. The method of claim 1, wherein said blending step blends a stored orange juice as the another orange juice source.

4. The method of claim 1, wherein said blending step incorporates up to about 80 volume percent of said extracted orange juice.

5. The method of claim 1, wherein said blending step provides early season orange juice having a sensory green character which is less than that of Hamlin orange juice harvested at the time of said harvesting step.

6. The method of claim 1, wherein said blending step provides early season orange juice having a sensory bitterness character which is less than that of Hamlin orange juice harvested at the time of said harvesting step.

7. The method of claim 1, wherein said blending step provides early season orange juice having a sensory feeling factors character which is less than that of Hamlin orange juice harvested at the time of said harvesting step.

8. The method of claim 1, wherein said blending step provides early season orange juice having a sensory sourness character which is less than that of Hamlin orange juice harvested at the time of said harvesting step.

9. The method of claim 1, wherein said blending step provides early season orange juice having a sensory chemical notes character which is less than that of Hamlin orange juice harvested at the time of said harvesting step.

10. The method of claim 1, wherein said blending step provides early season orange juice-having a sensory total orange character which is greater than that of Hamlin orange juice harvested at the time of said harvesting step.

11. The method of claim 1, wherein said blending step provides early season orange juice having a sensory raw orange character which is greater than that of Hamlin orange juice harvested at the time of said harvesting step.

12. The method of claim 1, wherein said collecting step provides early season orange juice having a Color Number of at least 1 CN greater than Hamlin orange juice harvested at the time of said harvesting step.

13. The method of claim 1, wherein said cultivar within the Seleta family is selected from the group consisting of Seleta Branca, Seleta Coroa-do-Rei, Seleta de Itaborai, Seleta Vermelha, and combinations thereof.

14. The method of claim 1, wherein said collecting step provides a juice having a Brix-to-acid ratio (BAR) during the months of October and November which meets or exceeds the Orange Fruit Maturity Standards of the Florida Department of Agriculture & Consumer Services.

15. The method of claim 1, wherein: said blending step provides early season orange juice having a sensory green character which is less than that of Hamlin orange juice harvested at the time of said harvesting step; said collecting step provides a juice having a Brix-to-acid ratio (BAR) during the months of October and November which meets or exceeds the Orange Fruit Maturity Standards of the Florida Department of Agriculture & Consumer Services; and said collecting step provides early season orange juice having a Color Number of at least 1 CN greater than Hamlin orange juice harvested at the time of said harvesting step.

16. A method of preparing not from concentrate orange juice from oranges, comprising the steps of:
harvesting fruit of a very early season orange cultivar having juice with sensory characteristics superior to juice extracted from Hamlin oranges and an early season color which has a Color Number which is at least about 1 CN greater than that of corresponding early season color of juice extracted from Hamlin oranges;
extracting juice from a plurality of the very early season orange cultivar fruit of the harvesting step, said extracting occurring during an extraction time period which is early in the orange growing season;
collecting the juice from the extracting step in order to provide an orange juice source having a Color Number of at least 33 CN units; and
blending at least about 5 volume percent, based on the volume of the orange juice, of said juice from the extracting step with another juice in order to provide a not from concentrate orange juice product having a Color Number in excess of 33 CN units and a sensory profile superior to that of 100 percent Hamlin juice.

17. The method of claim 16, wherein said harvesting step occurs in October or November in the Northern Hemisphere.

18. The method of claim 16, wherein said blending step provides early season orange juice having a sensory green character which is less than that of Hamlin orange juice harvested at the time of said harvesting step.

19. The method of claim 16, wherein said blending step provides early season orange juice having a sensory bitterness character which is less than that of Hamlin orange juice harvested at the time of said harvesting step.

20. The method of claim 16, wherein: said blending step provides early season orange juice having a sensory green character which is less than that of Hamlin orange juice harvested at the time of said harvesting step; said collecting step provides a juice having a Brix-to-acid ratio (BAR) during the months of October and November which meets or exceeds the Orange Fruit Maturity Standards of the Florida Department of Agriculture & Consumer Services; and said collecting step provides early season orange juice having a Color Number of at least 1 CN greater than Hamlin orange juice harvested at the time of said harvesting step.

21. The method of claim 16, wherein said blending step blends a stored orange juice as the another orange juice source.

22. The method of claim 16, wherein said collecting step provides a juice having a Brix-to-acid ratio (BAR) during the months of October and November which meets or exceeds the Orange Fruit Maturity Standards of the Florida Department of Agriculture & Consumer Services.

23. The method of claim 16, wherein said harvesting step selects a cultivar having an early season color of at least about 2 CN greater than Hamlin orange juice of a corresponding harvest time.

24. A method of preparing not from concentrate orange juice from oranges, comprising the steps of:
harvesting an orange cultivar fruit selected from the group consisting of Westin cultivars, Ruby Nucellar cultivars, Itaborai cultivars, and combinations thereof;
extracting juice from a volume of said orange cultivar fruit;
collecting the resulting extracted orange juice as an early season orange juice source having a Color Number of at least 33 CN units;
combining the extracted early season orange juice from said extracting step with another juice in order to provide a not from concentrate orange juice product having at least about 5 volume percent of said early season orange juice, based on the total volume of the juice; and
said not from concentrate orange juice has a sensory green character superior to that of said another juice.

25. The method of claim 24, wherein said combining step provides a not from concentrate orange juice product having a Color Number which is greater than 33 CN units.

26. The method of claim 24, wherein said harvesting step occurs in October or November in the Northern Hemisphere.

27. The method of claim 24, wherein said collecting step provides early season orange juice having a Color Number of at least 1 CN greater than Hamlin orange juice harvested at the time of said harvesting step.

28. The method of claim 24, wherein said collecting step provides early season orange juice having a Color Number of at least 2 CN greater than Hamlin orange juice harvested at the time of said harvesting step.

29. The method of claim 24, wherein said collecting step provides a juice having a Brix-to-acid ratio (BAR) during the months of October and November which meets or exceeds the Orange Fruit Maturity Standards of the Florida Department of Agriculture & Consumer Services.

30. A method of preparing not from concentrate orange juice from oranges, comprising the steps of:
harvesting fruit of an orange cultivar which provides juice during the months of October and November having a sensory profile superior to that of juice provided by Hamlin oranges during the months of October and November, respectively, and having a Color Number which is more intense than juice provided by Hamlin oranges during the months of October and November, respectively;
extracting juice from the orange cultivar of the selecting step, said extracting occurring during an extraction time period which is very early in the orange harvesting season;
collecting the juice from the extracting step in order to provide an orange juice source having a Color Number of at least 33 CN units; and
blending said juice from the extracting step with another juice in order to provide an orange juice product having a sensory profile superior to that of said Hamlin juice and a color value in excess of 33 CN units.

31. The method in accordance with claim 30, wherein said collecting step provides a juice having a Brix-to-acid ratio (BAR) values during the months of October and November which meets or exceed the Orange Fruit Maturity Standards of the Florida Department of Agriculture & Consumer Services.

32. The method in accordance with claim 30, wherein said collecting step provides a juice having a Brix value which meets or exceeds the minimum total solids requirement during the months of October and November of the Florida Department of Agriculture & Consumer Services, and this juice of said collecting step provides a Brix-to-acid ratio (BAR) during the months of October and November which meets or exceeds the Orange Fruit Maturity Standards of the Florida Department of Agriculture & Consumer Services for BAR during the months of October and November.

33. The method of claim 30, wherein said collecting step provides early season orange juice having a Color Number of at least 1 CN greater than Hamlin orange juice harvested at the time of said harvesting step.

34. The method of claim 30, wherein said collecting step provides early season orange juice having a Color Number of at least 2 CN greater than Hamlin orange juice harvested at the time of said harvesting step.

35. The method of claim 30, wherein said blending step provides a product having a Color Number of at least about 35 CN units.

36. The method of claim 30, wherein: said blending step provides early season orange juice having a sensory green character which is less than that of Hamlin orange juice harvested at the time of said harvesting step; said collecting step provides a juice having a Brix-to-acid ratio (BAR) during the months of October and November which meets or exceeds the Orange Fruit Maturity Standards of the Florida Department of Agriculture & Consumer Services; and said collecting step provides early season orange juice having a Color Number of at least 1 CN greater than Hamlin orange juice harvested at the time of said harvesting step.

37. A not from concentrate orange juice prepared in accordance with a process comprising the steps of:
harvesting a very early season orange cultivar having juice with early season color of greater intensity than Hamlin orange juice while also exhibiting sensory qualities superior to the sensory qualities of Hamlin orange juice, said harvesting step including selecting a cultivar within the Seleta family of cultivars, a Westin cultivar, a Ruby Nucellar cultivar, or a combination of these very early season cultivars;
extracting juice from a volume of said very early season oranges of said harvesting step;
collecting the resulting extracted orange juice as an early season orange juice having a Color Number of at least 33 CN units; and
blending at least about 5 volume percent, based on the total volume of the juice, of said extracted early season orange juice with another orange juice source in order to provide a not from concentrate orange juice product having a Color Number in excess of 33 CN units and sensory qualities which are superior to said another orange juice source.

38. The orange juice of claim 37, wherein said very early season orange cultivars are harvested in October.

39. The orange juice of claim 37, wherein said very early season orange cultivars are harvested in November.

40. The orange juice of claim 37, wherein said extracted early season orange juice comprises up to about 80 volume percent of the not from concentrate juice.

41. The orange juice of claim 37, wherein said extracted early season orange juice has a Color Number which is at least 1 CN greater than Hamlin orange juice.

42. The orange juice of claim 37, wherein: said early season orange juice has a sensory green character which is less than that of Hamlin orange juice harvested at the time of said harvesting step; said juice has a Brix-to-acid ratio (BAR) during the months of October and November which meets or exceeds the Orange Fruit Maturity Standards of the Florida Department of Agriculture & Consumer Services; and said early season orange juice has a Color Number of at least 1 CN greater than Hamlin orange juice harvested at the time of said harvesting step.

43. The orange juice of claim 37, wherein said early season orange juice has a Brix value which meets or exceeds the minimum total solids requirement during the months of October and November of the Florida Department of Agriculture & Consumer Services, and this juice of said collecting step provides a Brix-to-acid ratio (BAR) during the months of October and November which meets or exceeds the Orange Fruit Maturity Standards of the Florida Department of Agriculture & Consumer Services for BAR during the months of October and November.

44. A not from concentrate orange juice prepared in accordance with a process comprising the steps of:
harvesting fruit of a very early season orange cultivar having juice with an early season color which has a Color Number which is at least about 1 CN greater than that of corresponding early season color of juice extracted from Hamlin oranges, while also exhibiting sensory qualities superior to the sensory qualities of Hamlin orange juice, said superior sensory qualities including a reduced green character;
extracting juice from a plurality of the very early season orange cultivar of the harvesting step, said extracting occurring during an extraction time period which is early in the orange growing season;
collecting the juice from the extracting step in order to provide an orange juice source having a Color Number of at least 33 CN units; and
blending at least about 5 volume percent of said juice from the extracting step with another juice in order to provide a not from concentrate orange juice product having a Color Number in excess of 33 CN units and improved sensory characteristics.

45. A not from concentrate orange juice composition comprising a blend of:
at least about 1 percent by volume of an orange juice supply, based upon the total volume of the composition;
up to about 99 volume percent of a very early season fresh orange juice, based upon the total volume of the composition, said very early season juice having a sensory profile superior to that of 100 percent Hamlin orange juice from fruit harvested at about the same time as fruit from which said very early season juice originates; and
said fruit from which the very early season fresh orange juice originates is an early season round orange cultivar selected from the group consisting of a cultivar within the Seleta family of cultivars, a Westin cultivar, a Ruby Nucellar cultivar, or a combination of these early season cultivars.

46. The composition of claim 45, wherein said orange juice supply comprises at least about 10 percent by volume, and said very early season fresh juice comprises up to about 90 percent by volume.

47. The composition of claim 45, wherein said orange juice supply comprises at least about 20 percent by volume, and said very early season fresh juice comprises up to about 80 percent by volume.

48. The composition of claim 45, wherein: said very early season orange juice has a sensory green character which is less than that of the 100 percent Hamlin orange juice; said juice has a Brix-to-acid ratio (BAR) during the months of October and November which meets or exceeds the Orange Fruit Maturity Standards of the Florida Department of Agriculture & Consumer Services; and said very early season orange juice has a Color Number of at least 1 CN greater than the 100 percent Hamlin orange juice.

49. The composition of claim 45, wherein said blend has a sensory green character which is less than that of the 100 percent Hamlin orange juice.

50. The composition of claim 45, wherein said blend has a sensory bitterness character which is less than that of the 100 percent Hamlin orange juice.

51. The composition of claim 45, wherein said orange juice supply is Hamlin orange juice.

52. The composition of claim 45, wherein said very early season juice is juice from Westin orange cultivars.

53. The composition of claim 45, wherein said very early season juice is juice from Itaborai orange cultivars.

54. The composition of claim 45, wherein said very early season juice is juice from Ruby Nucellar orange cultivars.

55. The composition of claim 45, wherein said very early season juice is juice from orange cultivars of the Seleta family.

56. A method of preparing an orange juice product incorporating an early season orange cultivar, comprising the steps of:
harvesting a very early season orange cultivar having juice with early season color of greater intensity than Hamlin orange juice while also exhibiting sensory qualities superior to the sensory qualities of Hamlin orange juice, said harvesting step including selecting a cultivar within the Seleta family of cultivars, or a combination of these very early season cultivars;
extracting juice from a volume of said very early season oranges of said harvesting step;
collecting the resulting extracted orange juice as an early season orange juice having a Color Number of at least 33 CN units; and
blending at least about 5 volume percent, based on the total volume of the orange juice, of said extracted early season orange juice with another orange juice source in order to provide an orange juice product having an enhanced sensory profile and a Color Number in excess of 33 CN units.

57. The method of claim 56, wherein said blending step blends a stored orange juice as the another orange juice source.

58. The method of claim 56, wherein said blending step incorporates up to about 80 volume percent of said extracted orange juice.

59. The method of claim 56, wherein said cultivar within the Seleta family is selected from the group consisting of Seleta Branca, Seleta Coroa-do-Rei, Seleta de Itaborai, Seleta Vermelha, and combinations thereof.

60. The method of claim 56, wherein: said blending step provides early season orange juice having a sensory green character which is less than that of Hamlin orange juice harvested at the time of said harvesting step; said collecting step provides a juice having a Brix-to-acid ratio (BAR) during the months of October and November which meets or exceeds the Orange Fruit Maturity. Standards of the Florida Department of Agriculture & Consumer Services; and said collecting step provides early season orange juice having a Color Number of at least 1 CN greater than Hamlin orange juice harvested at the time of said harvesting step.

61. The method of claim 56, wherein said harvesting step selects a cultivar having an early season color of at least about 2 CN greater than Hamlin orange juice of a corresponding harvest time.

62. The method of claim 56, wherein said blending step provides a product having a Color Number of at least about 35 CN units.

63. An orange juice prepared in accordance with a process comprising the steps of:
harvesting fruit of a very early season orange cultivar of the Seleta family of cultivars, said cultivar having juice with an early season color which has a Color Number which is at least about 1 CN greater than that of corresponding early season color of juice extracted from Hamlin oranges, while also exhibiting sensory qualities superior to the sensory qualities of Hamlin orange juice, said superior sensory qualities including a reduced green character;
extracting juice from a plurality of the very early season orange cultivar of the harvesting step, said extracting occurring during an extraction time period which is early in the orange growing season;
collecting the juice from the extracting step in order to provide an orange juice source having a Color Number of at least 33 CN units; and
blending at least about 5 volume percent of said juice from the extracting step with another juice in order to provide a not from concentrate orange juice product having a Color Number in excess of 33 CN units and improved sensory characteristics.

64. An orange juice composition comprising a blend of:
at least about 1 percent by volume of an orange juice supply, based upon the total volume of the composition;
up to about 99 volume percent of a very early season orange juice supply, based upon the total volume of the composition, said very early season juice having a sensory profile superior to that of 100 percent Hamlin orange juice from fruit harvested at about the same time as fruit from which said very early season juice originates; and
said fruit from which the very early season fresh orange juice originates is an early season round orange cultivar selected from within the Seleta family of cultivars, or a combination of these early season cultivars.

65. The composition of claim 64, wherein said orange juice supply comprises at least about 10 percent by volume, and said very early season juice comprises up to about 90 percent by volume.

66. The composition of claim 64, wherein said orange juice supply comprises at least about 20 percent by volume, and said very early season juice comprises up to about 80 percent by volume.

67. The composition of claim 64, wherein: said very early season orange juice has a sensory green character which is less than that of the 100 percent Hamlin orange juice; said juice has a Brix-to-acid ratio (BAR) during the months of October and November in the Northern Hemisphere which meets or exceeds the Orange Fruit Maturity Standards of the Florida Department of Agriculture & Consumer Services; and said very early season orange juice has a Color Number of at least 1 CN greater than the 100 percent Hamlin orange juice.

68. The composition of claim 64, wherein said orange juice supply is Hamlin orange juice.
